(19) United States
(12) Patent Application Publication
(10) Pub. No.: US 2026/0340033 A1
(43) Pub. Date: Oct. 29, 2026

(54) METHOD AND APPARATUS FOR ANSWERING BASED ON A LONG-FORM VIDEO, ELECTRONIC DEVICE AND MEDIA

(71) Applicant: BAIDU.COM TIMES TECHNOLOGY (BEIJING) CO., LTD., BEIJING (CN)

(72) Inventors: Yuchen LI, BEIJING (CN); Yulong HUI, BEIJING (CN); Rui KONG, BEIJING (CN); Xinran CHEN, BEIJING (CN); Dawei YIN, BEIJING (CN)

(73) Assignee: BAIDU.COM TIMES TECHNOLOGY (BEIJING) CO., LTD., BEIJING (CN)

(21) Appl. No.: 19/705,224

(22) Filed: Jun. 11, 2026

(30) Foreign Application Priority Data
Apr. 24, 2026 (CN) 202610560246.7

(51) Int. Cl. G06F 16/783; G06F 16/71; G06F 16/75; G06F 16/78; G06V 20/40

(52) U.S. Cl. CPC G06F 16/783; G06F 16/71; G06F 16/75; G06F 16/7867; G06V 20/49

(57) ABSTRACT

A method includes: obtaining a query instruction to be answered; obtaining multi-level index data corresponding to video information of different granularities of the target video for answering the query instruction; and generating a first identifier and first content, or generating a second identifier and second content, by a large language model based on the query instruction and first-level index data, the first content includes an answer generated based on the first-level index data, the first and second identifiers are used to identify whether the first-level index data is sufficient or insufficient for answering the query instruction individually; the second content includes first content index information to be used for performing content retrieval in the second-level index data to answer the query instruction.

### CROSS REFERENCE TO RELATED APPLICATION

This application claims priority to Chinese patent application No. 202610560246.7 filed on Apr. 24, 2026, the contents of which are hereby incorporated by reference in their entirety for all purposes.

### TECHNICAL FIELD

The present disclosure relates to the field of artificial intelligence, in particular to the technical fields of large models, intelligent question answering, and video processing, and specifically relates to a method and an apparatus for answering based on a long-form video, an electronic device, a computer-readable storage medium, and a computer program product.

### BACKGROUND

Artificial intelligence is the discipline of studying how computers can simulate certain thinking processes and intelligent behaviors of a human being (such as learning, reasoning, thinking, planning, etc.), and there are both hardware-level and software-level technologies. The artificial intelligence hardware technologies generally include technologies such as sensors, special artificial intelligence chips, cloud computing, distributed storage, big data processing, etc. The artificial intelligence software technologies mainly include computer vision technology, speech recognition technology, natural language processing technology, machine learning/deep learning, big data processing technology, knowledge graph technology and other major technological directions.

Human-computer interaction is a method by which humans interact with machines using natural language. With the continuous advancement of artificial intelligence technology, it has been enabled that machines are capable of comprehending information outputted by humans, understanding the underlying meaning of that information, and providing appropriate feedback. In these operations, the accurate understanding of semantics, the speed of feedback, and the provision of relevant opinions or suggestions all become factors influencing the smoothness of human-computer interaction.

The methods described in this section are not necessarily methods that have been previously conceived or employed. Unless otherwise indicated, it should not be assumed that any method described in this section is considered to be the prior art only due to its inclusion in this section. Similarly, the problems mentioned in this section should not be assumed to be recognized in any prior art unless otherwise indicated.

### SUMMARY

The present disclosure provides a method, an apparatus and an electronic device for answering based on a long-form video, a computer-readable storage medium, and a computer program product.

According to one aspect of the present disclosure, a method for answering based on a long-form video is provided, including: performing a first operation, wherein the first operation includes: obtaining a query instruction to be answered; obtaining multi-level index data for answering the query instruction, wherein the multi-level index data includes: first-level index data and second-level index data, wherein the multi-level index data corresponds to video information of different granularities of the target video, and the higher the level of the index data, the finer the granularity of the video information; and generating a first identifier and first content, or generating a second identifier and second content, by a large language model based on the query instruction and the first-level index data, wherein the first content includes an answer corresponding to the query instruction, wherein the answer is generated based on the first-level index data, and the first identifier is used to identify that the content in the first-level index data is sufficient for answering the query instruction; wherein the second content includes corresponding first content index information for answering the query instruction, wherein the second identifier is used to identify that the content in the first-level index data is insufficient for answering the query instruction, wherein the first content index information is used for performing content retrieval in the second-level index data to answer the query instruction, and wherein the first content index information is used for obtaining the answer to the query instruction.

According to another aspect of the present disclosure, an electronic device is provided, including: a memory storing one or more programs configured to be executed by one or more processors, the one or more programs including instructions for performing operations including: performing a first operation, wherein the first operation comprises: obtaining a query instruction to be answered; obtaining multi-level index data for answering the query instruction, wherein the multi-level index data comprises: first-level index data and second-level index data, wherein the multi-level index data corresponds to video information of different granularities of the target video, and the higher the level of the index data, the finer the granularity of the video information; and generating a first identifier and first content, or generating a second identifier and second content, by a large language model based on the query instruction and the first-level index data, wherein the first content comprises an answer corresponding to the query instruction, wherein the answer is generated based on the first-level index data, and the first identifier is used to identify that the content in the first-level index data is sufficient for answering the query instruction; wherein the second content comprises corresponding first content index information for answering the query instruction, wherein the second identifier is used to identify that the content in the first-level index data is insufficient for answering the query instruction, wherein the first content index information is used for performing content retrieval in the second-level index data to answer the query instruction, and wherein the first content index information is used for obtaining the answer to the query instruction.

According to another aspect of the present disclosure, a non-transitory computer-readable storage medium storing computer instructions is provided, wherein the computer instructions are used to cause the computer to perform the following operations: performing a first operation, wherein the first operation comprises: obtaining a query instruction to be answered; obtaining multi-level index data for answering the query instruction, wherein the multi-level index data comprises: first-level index data and second-level index data, wherein the multi-level index data corresponds to video information of different granularities of the target video, and the higher the level of the index data, the finer the granularity of the video information; and generating a first identifier and first content, or generating a second identifier and second content, by a large language model based on the query instruction and the first-level index data, wherein the first content comprises an answer corresponding to the query instruction, wherein the answer is generated based on the first-level index data, and the first identifier is used to identify that the content in the first-level index data is sufficient for answering the query instruction; wherein the second content comprises corresponding first content index information for answering the query instruction, wherein the second identifier is used to identify that the content in the first-level index data is insufficient for answering the query instruction, wherein the first content index information is used for performing content retrieval in the second-level index data to answer the query instruction, and wherein the first content index information is used for obtaining the answer to the query instruction.

It should be understood that the content described in this section is not intended to identify key or important features of the embodiments of the present disclosure, nor is it intended to limit the scope of the present disclosure. Other features of the present disclosure will become readily understood from the following description.

### BRIEF DESCRIPTION OF THE DRAWINGS

The drawings exemplarily illustrate embodiments and constitute a part of the specification, and are used in conjunction with the textual description of the specification to explain the example implementations of the embodiments. The illustrated embodiments are for illustrative purposes only and do not limit the scope of the claims. Throughout the drawings, like reference numerals refer to similar but not necessarily identical elements.

FIG. 1 illustrates a schematic diagram of an example system in which various methods described herein may be implemented according to embodiments of the present disclosure.

FIG. 2 illustrates a flowchart of a method for answering based on a long-form video according to embodiments of the present disclosure;

FIGS. 3-6 respectively illustrate flowcharts of methods for answering based on a long-form video according to embodiments of the present disclosure;

FIGS. 7-10 respectively illustrate structural block diagrams of apparatuses for answering based on a long-form video according to embodiments of the present disclosure;

FIG. 11 illustrates a structural block diagram of an example electronic device that can be used to implement embodiments of the present disclosure.

### DETAILED DESCRIPTION OF THE EMBODIMENTS

The example embodiments of the present disclosure are described below in conjunction with the accompanying drawings, including various details of the embodiments of the present disclosure to facilitate understanding, and they should be considered as example only. Therefore, one of ordinary skill in the art will recognize that various changes and modifications may be made to the embodiments described herein without departing from the scope of the present disclosure. Similarly, descriptions of well-known functions and structures are omitted in the following description for the purpose of clarity and conciseness.

In the present disclosure, unless otherwise specified, the terms " first ", " second " and the like are used to describe various elements and are not intended to limit the positional relationship, timing relationship, or importance relationship of these elements, and such terms are only used to distinguish one element from another. In some examples, the first element and the second element may refer to the same instance of the element, while in some cases they may also refer to different instances based on the description of the context.

The terminology used in the description of the various examples in this disclosure is for the purpose of describing particular examples only and is not intended to be limiting. Unless the context clearly indicates otherwise, if the number of elements is not specifically defined, the element may be one or more. In addition, the terms "and/or" used in the present disclosure encompass any one of the listed items and all possible combinations thereof.

Embodiments of the present disclosure will be described in detail below with reference to the accompanying drawings.

FIG. 1 illustrates a schematic diagram of an example system 100 in which various methods and apparatuses described herein may be implemented in accordance with embodiments of the present disclosure. Referring to FIG. 1, the system 100 includes one or more client devices 101, 102, 103, 104, 105 and 106, a server 120, and one or more communication networks 110 that couple one or more client devices to the server 120. The client devices 101, 102, 103, 104, 105, and 106 may be configured to execute one or more applications.

In embodiments of the present disclosure, the server 120 may run one or more services or software applications that enable execution of a method for answering based on a long-form video.

In some embodiments, the server 120 may also provide other services or software applications, which may include non-virtual environments and virtual environments. In some embodiments, these services may be provided as web-based services or cloud services, such as to the user of the client devices 101, 102, 103, 104, 105, and/or 106 under a Software as a Service (SaaS) model.

In the configuration shown in FIG. 1, the server 120 may include one or more components that implement functions performed by the server 120. These components may include software components, hardware components, or a combination thereof that are executable by one or more processors. A user operating the client devices 101, 102, 103, 104, 105, and/or 106 may sequentially utilize one or more client applications to interact with the server 120 to utilize the services provided by these components. It should be understood that a variety of different system configurations are possible, which may be different from the system 100. Therefore, FIG. 1 is an example of a system for implementing the various methods described herein and is not intended to be limiting.

The user may use the client devices 101, 102, 103, 104, 105, and/or 106 to input a query instruction, obtain an answer etc. The client devices may provide an interface that enables the user of the client devices to interact with the client devices. The client devices may also output information to the user via the interface. Although FIG. 1 depicts only six client devices, those skilled in the art will be able to understand that the present disclosure may support any number of client devices.

The client devices 101, 102, 103, 104, 105, and/or 106 may include various types of computer devices, such as portable handheld devices, general-purpose computers, such as personal computers and laptop computers, workstation computers, wearable devices, smart screen devices, self-service terminal devices, service robots, gaming systems, thin clients, various messaging devices, sensors, or other sensing devices, and the like. These computer devices may run various types and versions of software applications and operating systems, such as Microsoft Windows, Apple iOS, Unix-like operating systems, Linux or Linux-like operating systems (e.g., Google Chrome OS); or include various mobile operating systems, such as Microsoft Windows Mobile OS, iOS, Windows Phone, Android. The portable handheld devices may include cellular telephones, smart phones, tablet computers, personal digital assistants (PDAs), and the like. The wearable devices may include head-mounted displays, such as smart glasses, and other devices. The gaming systems may include various handheld gaming devices, Internet-enabled gaming devices, and the like. The client devices can perform various different applications, such as various applications related to the Internet, communication applications (e.g., e-mail applications), Short Message Service (SMS) applications, and may use various communication protocols.

The network 110 may be any type of network well known to those skilled in the art, which may support data communication using any of a variety of available protocols (including but not limited to TCP/IP, SNA, IPX, etc.). By way of example only, one or more networks 110 may be a local area network (LAN), an Ethernet-based network, a token ring, a wide area network (WAN), an Internet, a virtual network, a virtual private network (VPN), an intranet, an external network, a blockchain network, a public switched telephone network (PSTN), an infrared network, a wireless network (for example, Bluetooth, WiFi), and/or any combination of these and/or other networks.

The server 120 may include one or more general-purpose computers, a dedicated server computer (e.g., a PC (personal computer) server, a UNIX server, a mid-end server), a blade server, a mainframe computer, a server cluster, or any other suitable arrangement and/or combination. The server 120 may include one or more virtual machines running a virtual operating system, or other computing architectures involving virtualization (e.g., one or more flexible pools of a logical storage device that may be virtualized to maintain virtual storage devices of a server). In various embodiments, the server 120 may run one or more services or software applications that provide the functions described below.

The computing unit in the server 120 may run one or more operating systems including any of the operating systems described above and any commercially available server operating system. The server 120 may also run any of a variety of additional server applications and/or intermediate layer applications, including a HTTP server, an FTP server, a CGI server, a Java server, a database server, etc.

In some implementations, the server 120 may include one or more applications to analyze and merge data feeds and/or event updates received from the user of the client devices 101, 102, 103, 104, 105, and/or 106. The server 130 may also include one or more applications to display the data feeds and/or the real-time events via one or more display devices of the client devices 101, 102, 103, 104, 105, and/or 106.

In some embodiments, the server 120 may be a server of a distributed system, or a server incorporating a blockchain. The server 120 may also be a cloud server, or an intelligent cloud computing server or an intelligent cloud host with an artificial intelligence technology. The cloud server is a host product in a cloud computing service system to overcome the defects of management difficulty and weak service expansibility exiting in a traditional physical host and virtual private server (VPS) service.

The system 100 may also include one or more databases 130. In certain embodiments, these databases may be used to store data and other information. For example, one or more of the databases 130 may be used to store information such as the target video, data at various levels. The databases 130 may reside in various locations. For example, the database used by the server 120 may be local to the server 120, or may be remote from the server 120 and may communicate with the server 120 via a network-based or dedicated connection. The databases 130 may be of different types. In some embodiments, the database used by the server 120 may be, for example, a relational database. One or more of these databases may store, update, and retrieve data to and from the database in response to a command.

In some embodiments, one or more of the databases 130 may also be used by an application to store application data. The databases used by the application may be different types of databases, such as a key-value repository, an object repository, or a conventional repository supported by a file system.

The system 100 of FIG. 1 may be configured and operated in various ways to enable application of various methods and apparatuses described according to the present disclosure.

At present, automated understanding of long-form video content is widely required in application scenarios such as intelligent monitoring, content governance, information extraction, and platform interaction. Although vision-language models (VLMs) have demonstrated excellent zero-shot capabilities in visual analysis, efficient deployment and practical application of VLMs in long-form video understanding still face the following core technical challenges:
I. Problem of extremely high computational cost and information loss caused by directly using a VLM: although recent vision-language models have demonstrated remarkable capabilities, significant limitations still exist when the vision-language models are directly deployed for long-form video processing. Directly inputting a large number of video sequence frames into a VLM may result in extremely high computational cost. For a video lasting several hours, at a frame rate of 2 FPS, the total number of visual tokens generated from the video may reach several million. Such large number of visual tokens corresponds to high computational cost and may exceed context window limitations of most models. To address these contextual constraints, existing VLM inference typically employs down sampling strategies to reduce the number of input frames. However, such sparse sampling scheme may lead to loss of key visual details, thereby reducing the accuracy of responses of the model.
II. Problem of lack of global temporal logic caused by fragmented processing in existing agent frameworks: to alleviate the defects of directly using a VLM, agent-based frameworks have emerged. However, many existing agent frameworks mainly perform analysis based on fragmented collections of frames. This may destroy the original temporal continuity of the video and fragment the global logical information of the video. As a result, such frameworks cannot effectively capture temporal relationships in the video, yet for a long-form video, it is indispensable to understand these temporal causal relationships and to grasp the overall narrative progression.
III. Problem of high latency and high token consumption caused by complex iterations of agents in high-frequency online scenarios: another key obstacle faced by existing agent frameworks in practical application environments lies in that such frameworks generally rely on heavy online processing procedures to handle each query. These systems often decompose a task and iteratively perform operations such as planning, reasoning, frame selection, and information localization, including iterative reflection and complex tool-calling loops. The high complexity of these operations usually forces the systems to use expensive closed-source LLMs. The combination of heavy computational overhead and complex online iterations result in excessive system latency and high token consumption costs, and therefore is not suitable for deployment in online scenarios requiring frequent responses to user queries.

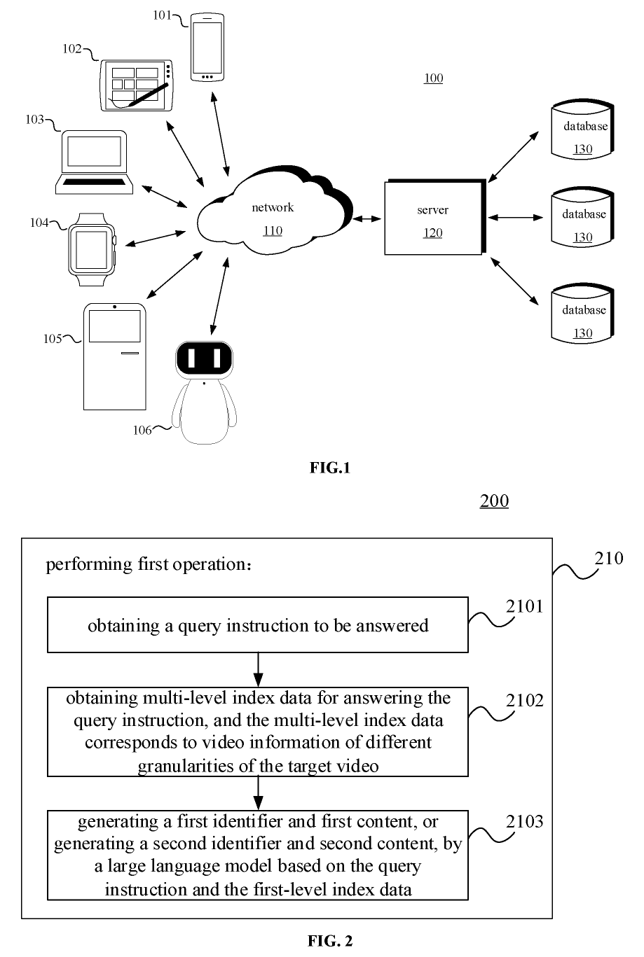

Accordingly, embodiments of the present disclosure provide a method for answering based on a long-form video. FIG. 2 illustrates a flowchart of a method for answering based on a long-form video according to embodiments of the present disclosure, as shown in FIG. 2, method 200 includes: performing a first operation (step 210), wherein the first operation includes: obtaining a query instruction to be answered (step 2101); obtaining multi-level index data for answering the query instruction, wherein the multi-level index data includes: first-level index data and second-level index data, wherein the multi-level index data corresponds to video information of different granularities of the target video, and the higher the level of the index data, the finer the granularity of the video information (step 2102); and generating a first identifier and first content, or generating a second identifier and second content, by a large language model based on the query instruction and the first-level index data (step 2103).

In embodiments of the present disclosure, the first content includes an answer corresponding to the query instruction, wherein the answer is generated based on the first-level index data, and the first identifier is used to identify that the content in the first-level index data is sufficient for answering the query instruction;

In embodiments of the present disclosure, the second content includes corresponding first content index information for answering the query instruction, wherein the second identifier is used to identify that the content in the first-level index data is insufficient for answering the query instruction, wherein the first content index information is used for performing content retrieval in the second-level index data to answer the query instruction, and wherein the first content index information is used for obtaining the answer to the query instruction.

According to embodiments of the present disclosure, by introducing a multi-level indexing mechanism, the problems of video memory overflow and omission of key frames caused by directly inputting a large amount of raw long-form video data into a model are avoided, and the efficiency and accuracy of long-form video content understanding can be significantly improved. This on-demand retrieval and layer-by-layer refinement processing logic enables rapid response to simple queries at a macro level, while also enables precise locating through high-level indexing when complex, long-span video analysis requirements are encountered, thereby achieving a balance between high performance and high accuracy in scenarios such as intelligent monitoring, content governance, and platform interaction.

In the embodiments of the present disclosure, the multi-level index data for answering the query instruction may be pre-processed index data. For example, the target video may be processed offline in advance to construct the multi-level index data including multiple granularities; then, during the online processing after obtaining the query instruction, the index data may be directly obtained to adaptively navigate data to answer the query instruction.

In the embodiments of the present disclosure, the multi-level index data pre-constructed based on the target video is centered on representing the target video by video information at different levels of granularity. For example, the first-level index data may be a text summary or a feature vector set in units of video frame groups or key scenes, which requires less storage space and is suitable for rapid global coarse screening; in contrast, the second-level index data may be refined to specific action description, target trajectory coordinates, or detailed features of a specific frame.

Through such hierarchical design, the retrieval depth may be dynamically selected based on the complexity of the query instruction. The video information at different granularities specifically reflects such hierarchical differences, the video information at lower granularity corresponds to a smaller level number, which is represented as descriptions of the overall semantic, theme, or rough timeline of the video, for example a person enters a room and conducts a conversation”; as the number of levels increases, the granularity of the video information becomes finer, which is represented as characterization of local details or microscopic temporal sequences, for example, “at 05 minutes and 12 seconds, the person's right hand picks up a cup,” or specific pixel-level feature data.

When the first-level index data is insufficient to directly generate the final answer, the second identifier and first-level content index information may be generated. The first-level content index information essentially serves as a navigational pointer or key retrieval term linking data across different levels, and it is the key clue derived after the interaction between the current query instruction and the first-level index data. For example, if the query instruction is “When did the person wearing blue clothes fall down in the video?” and the first-level index only indicates “A falling behavior occurs in a middle segment of the video.”, in this case, the first-level content index information may be generated as “locating the starting-frame range corresponding to the falling behavior of the person wearing blue clothes”, this information may serve as a retrieval instruction to guide the system into the second-level index at a finer granularity, to precisely extract fine-grained features near the specific timestamp, thereby ultimately obtaining an accurate answer capable of answering the query instruction.

According to some embodiments, the first-level index data includes: a first descriptive text corresponding to each first video segment in a first video segment set obtained by performing video segmentation on the target video; the second-level index data includes: a second descriptive text corresponding to each second video segment in a second video segment set obtained by performing video segmentation on the target video.

Wherein, the first-level index data and the second-level index data correspond to different segmentation granularities of the target video. That is, the video duration corresponding to each second video segment is not greater than the video duration corresponding to each first video segment, and the number of second video segments in the second video segment set is greater than the number of first video segments in the first video segment set.

Therefore, in some embodiments, the first identifier and first content, or the second identifier and second content are generate by the large language model based on the query instruction and each first descriptive text.

Therefore, in some embodiments, the generated second content may, for example, include: instruction text obtained by rewriting the query instruction, that is, the corresponding first content index information for answering the query instruction may be the instruction text obtained by rewriting the query instruction. Thus, content retrieval may be performed, based on this instruction text, in the second-level index data to answer the query instruction.

For example, by performing similarity calculation on the rewritten instruction text and the second description text corresponding to each second video segment, at least one second video segment for answering the query instruction is obtained, and then the corresponding answer is generated based on the at least one second video segment.

According to some embodiments, the second descriptive text includes: a visual descriptive text and an audio text corresponding to the corresponding second video segment, wherein the visual descriptive text is obtained by a visual language model based on at least one video frame in the corresponding second video segment and the audio text corresponding to the corresponding second video segment.

In some examples, the audio text corresponding to the second video segment may be text obtained by performing text conversion on the audio corresponding to the second video segment, for example, by extracting the audio text corresponding to the second video segment using automatic speech recognition (ASR) technology.

In some embodiments, the second descriptive text further includes visual descriptive text. The visual descriptive text is obtained by a visual-language model based on at least one video frame in the second video segment and the audio text corresponding to the second video segment. Specifically, for each second video segment, at least one video frame in the second video segment (such as video frames corresponding to different scenes) may be obtained, and the at least one video frame and the audio text corresponding to the second video segment are input into the vision-language model to obtain the visual description text, output by the vision-language model, corresponding to the second video segment.

In the embodiments of the present disclosure, the Vision-Language Model (VLM) is a multimodal generative artificial intelligence system that implements comprehensive processing of images, text, and videos by combining a large language model with a visual encoder. As a core branch of multimodal artificial intelligence, the Vision-Language Model enable semantic parsing and interactive generation of unstructured data such as images and videos by integrating visual perception and natural language understanding capabilities. Different from unimodal models, such as text-only LLMs or vision-only CNNs, VLMs may accecpt images and text as input and output text or responses in other forms. Typical tasks include: visual question answering (VQA), in which natural language questions are answered based on image content; image description generation, in which textual descriptions are generated for input images; and multimodal conversations, in which continuous conversations that are based on image content are supported.

To enhance semantic consistency, in the above embodiments, video frames and audio text are combined by the visual-language model (VLM) to generate comprehensive visual description text, thereby enhancing the content dimension and data accuracy of the second-level index data. As a result, a more accurate answer corresponding to the query instruction may be obtained, or it may be used to obtain more precise first target content for answering the query instruction.

According to some embodiments, the second-level index data further includes: the start timestamp and end timestamp of each second video segment in the target video; the first-level index data further includes: the start timestamp and end timestamp of each first video segment in the target video. The first content index information includes first time information, wherein the first time information represents time period information in the target video for answering the query instruction.

In some embodiments, generating the first identifier and first content, or generating the second identifier and second content by the large language model based on the query instruction and the first-level index data includes: generating the first identifier and first content, or generating the second identifier and second content by the large language model based on the query instruction, the first descriptive text, and the start timestamp and end timestamp of each first video segment in the target video.

In some embodiments, at this point, when the large language model generates the second identifier and the second content, the corresponding first content index information included in the second content for answering the query instruction is the first time information. The first time information represents the time period information in the target video for answering the query instruction. For example, from one minute and thirty seconds (1min30s) to two minutes and ten seconds (2min10s).

In some examples, the first time information may be complete start/end timestamp of a first video segment matched in the first-level index, or it may be a relatively ambiguous time range predicted by the large language model, which is not limited herein. By the first-time information and the start and end timestamps of each second video segment in the target video, at least one second video segment containing the first-time information may be obtained to serve as the content retrieved in the second-level index data for answering the query instruction.

In some embodiments, the first-time information may also be time-point information, that is, the time period information in the target video includes time-point information, which is not limited herein.

According to some embodiments, the second-level index data further includes: a text vector determined based on the second descriptive text. Furthermore, the first-level index data may be determined by the following operations: clustering, based on the text vector, second video segments that are semantically similar and temporally adjacent to form a plurality of video segment clusters; concatenating, for each video segment cluster in the plurality of video segment clusters, the second video segments in the video segment cluster in chronological order to obtain the first video segment corresponding to the video segment cluster; obtaining summary text corresponding to the target video; and obtaining, for each video segment cluster in the plurality of video segment clusters, the first description text corresponding to the first video segment corresponding to the video segment cluster by the large language model based on the summary text, the second description text and the start timestamp and end timestamp corresponding to each second video segment within the video segment cluster,. The first video segments respectively corresponding to the plurality of video segment clusters form the first video segment set.

In some embodiments, when the second descriptive text includes visual descriptive text, the text vector may be a vector corresponding to the visual descriptive text; alternatively, it may be a vector determined based on both the visual descriptive text and the audio text, which is not limited herein. For example, the visual descriptive text and the audio text may be input into a trained encoding model to obtain the text vector.

In some embodiments, second video segments that are semantically similar and temporally adjacent are clustered according to the text vector, until a predetermined number of clusters are formed, for example, by a clustering algorithm or a greedy algorithm. Then, the summary text corresponding to the target video, the audio text, the visual description text as well as the start and end timestamps of each second video segment within the cluster are input into the large language model to generate the first description text corresponding to the first video segment formed by concatenating each second video segment within the cluster.

By inputting the start and end timestamps of the corresponding second video segment when generating the first descriptive text, the chronological order of each second video segment and the proportion of its corresponding video content in the entire target video may be marked, thereby enabling the generated first descriptive text may more accurately summarize the content summary of the first video segment.

According to some embodiments, the multi-level index data further includes: zeroth-level index data, wherein the zeroth-level index data includes the summary text corresponding to the target video.

Therefore, in some embodiments, generating the first identifier and first content, or generating the second identifier and second content by the large language model based on the query instruction and the first-level index data includes: generating, based on the query instruction and the summary text, a strategy guidance text by the large language model, wherein the strategy guidance text is used for guiding the large language model to perform information retrieval in the first-level index data to answer the query instruction; and generating the first identifier and the first content, or generating the second identifier and the second content, by the large language model based on the strategy guidance text, the query instruction, the summary text, and the first-level index data.

In the above embodiments, the zeroth-level index data may also be pre-determined target video information, such as global summary text covering core topics and main events of the entire target video. For example, the summary text in the zeroth-level index data may be a condensed summary of core topics, main characters, key events, and an overall timeline of the target video. For example, the zeroth-level index may be a script-like description automatically generated based on visual features, or may be structured text including main chapter nodes of the video. For example, for a video relating to a basketball game, the summary text may contain: “This is a video of a basketball game between the Lakers and the Warriors, covering key stages such as player entrance, an intense first half, a halftime performance, and an overall game summary.” Such highly condensed text provides necessary global context for subsequent retrieval tasks.

In the embodiments where the second-level index data includes the second description text corresponding to each second video segment in the second video segment set obtained by performing video segmentation on the target video, to obtain the summary text corresponding to the target video, for example, the second description text of each second video segment corresponding to the target video may be input into the large language model to obtain the summary text.

In some embodiments, the strategy guidance text might be a query behavior suggestion, for generating the answer, generated based on the summary text and the user query instruction to serve as a “chain of thought” guide, aimed at decomposing complex query tasks into executable retrieval steps. For example, the user query instruction is “What celebration did the player perform after making the game-winning shot?”, and if the summary text prompt covers key stages such as player entrance, an intense first half, a halftime performance, and an overall game summary, the generated strategy guidance text may be: “Please first locate a later portion of the video, so as to focus on retrieving behaviors after scoring, and analyze close-up images of the player after the scoring.” Alternatively, the user query instruction is “Where did they go after swimming?”, and if the summary text summarized that this is a video recording of a trip, the generated strategy guidance might be: “Please locate the swimming scene and examine subsequent actions occurring thereafter.”

In this way, the strategy guidance text may guide the large language model to selectively retrieve specific action descriptions related to a particular scene in the vast first-level index data (for example, detailed action descriptions per minute), thereby efficiently generating the accurate first content or second content and ensuring the closed-loop completion of complex retrieval tasks.

In the above embodiment, the introduction of zeroth-level index data and the corresponding strategy guidance generation mechanism significantly enhances the logical planning capability and retrieval efficiency of the system when handling complex queries. By first generating the strategy guidance text based on the summary text of the target video, a clear retrieval “navigation map” may be constructed in the large-scale first-level index data, thereby preventing the large language model from performing unordered search in the full index data or generating hallucinated results. Such “plan-first, execute-later” architecture enables the model to preemptively understand the macro-level context of the video, and accordingly, when a query instruction having a large temporal span and complex semantic associations is encountered, a key information interval can be more accurately located, thereby reducing ineffective consumption of computational resources and improving logical coherence and accuracy of the generated response.

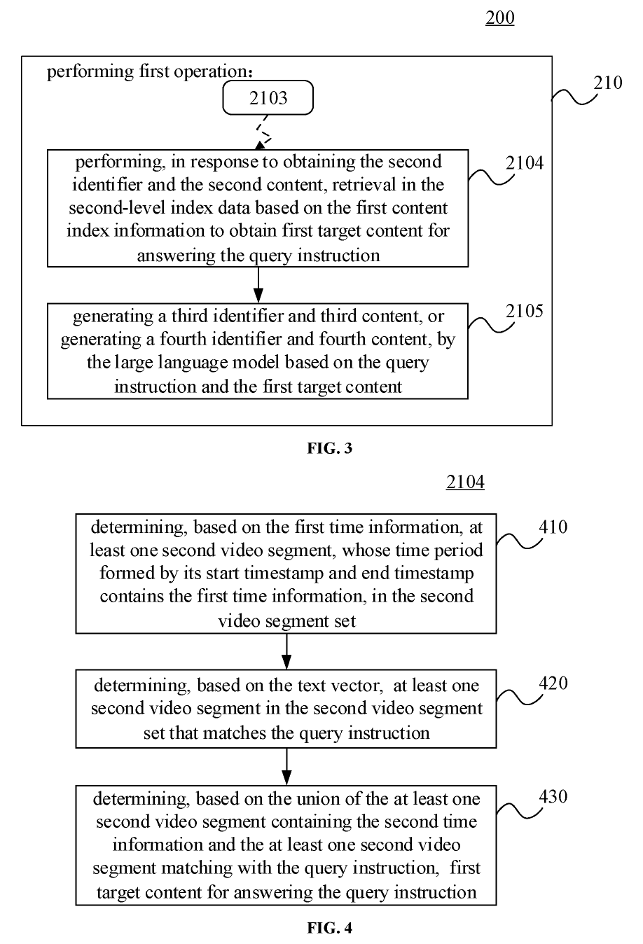

According to some embodiments, the multi-level index data further includes: third-level index data, wherein the third-level index data includes the target video. According to some embodiments, as shown in FIG. 3, the first operation (step 210) may further include: performing, in response to obtaining the second identifier and the second content, retrieval in the second-level index data based on the first content index information to obtain first target content for answering the query instruction (step 2104); generating a third identifier and third content, or generating a fourth identifier and fourth content, by the large language model based on the query instruction and the first target content (step 2105).

In the above embodiments, the third content includes the answer corresponding to the query instruction, wherein the answer is generated based on the second-level index data, and the third identifier is used to identify that the content in the second-level index data is sufficient for answering the query instruction; the fourth content includes corresponding second content index information for answering the query instruction, wherein the fourth identifier is used to identify that the content in the second-level index data is insufficient for answering the query instruction, wherein the second content index information is used for performing content retrieval in the target video for answering the query instruction, and wherein the second content index information is used for obtaining the answer to the query instruction.

For example, when an answer that satisfies the user requirement cannot be generated based on the first-level index data, the second identifier and second content are generated, and a retrieval may then be performed, based on the first content index information in the second content, in the second-level index data to obtain the first target content for answering the query instruction. The second-level index data is video information having a finer granularity than the first-level index data.

By introducing the third-level index data (i.e., raw video data) and the corresponding hierarchical fallback retrieval mechanism, a “baseline guarantee” capability is ensured when handling query instructions that are extremely complex or highly dependent on details. When neither the first-level nor the second-level index data can provide an answer with sufficient confidence, the raw video segment may be precisely located by generating a fourth identifier and utilizing the second-level content index information. Such mechanism effectively addresses the problem of “detail blind spots” that may be caused by information compression when a large language model processes a long-form video, and while ensuring retrieval speed, high robustness in video content understanding can be achieved, and final closure of the query result can be ensured.

In the above embodiments, the third-level index data directly includes the target video itself, which is the most fundamental and information-rich data source in the entire hierarchical system. Different from the representations at the preceding two levels of the index, such as textualized or vectorized representations, the third-level index provides a raw audio-video stream, enabling the extraction of extremely subtle features such as movement of a tiny object or specific environmental sound.

When the system determines that the second-level index data is still insufficient for answering the instruction, a fourth identifier and second-level content index information may be generated. For example, similar to the first content index information, the second content index information essentially serves as the navigational pointer or key retrieval term linking data across different levels, and it is the key clue derived after the interaction between the current query instruction and the first target content retrieved from the second-level index data. The second content index information serves as a precise “traceability marker,” carrying the locating parameters derived in the preceding retrieval process.

For example, when the first-level index data and second-level index data include the descriptive text corresponding to the corresponding video segment, the second content index information may be instruction text obtained by rewriting the query instruction based on the first target content. In another example, when the first-level index data and second-level index data include the descriptive text as well as the start and end timestamps corresponding to the corresponding video segment, the second content index information may further be refined timestamp information for answering the query instruction, or the combination of the instruction text obtained by rewriting the query instruction and the timestamp information, and/or other determined locating parameters for performing detail information retrieval in the target video, so as to answer the query instruction.

For example, if the query instruction relates to “whether a specific letter is present on a key handed by one person to another person,” and in the case that the second-level index data can only determine that “a key-handing action occurred,” the second-level content index information may locate the exact timestamp of that action and/or the spatial coordinate region in the video frame. By this index information, corresponding raw frames in the third-level index data (the target video) may be directly retrieved for super-resolution processing or visual feature re-analysis, thereby ultimately extracting the answer hidden in the raw pixels and completely eliminating the recognition risks caused by information asymmetry.

As described above, invocation of the third-level index typically involves “local decoding” or “slice extraction” of the raw video. Since directly processing a full video involves extremely high overhead, in the above embodiments, video retrieval and answer generation may be implemented more efficiently and accurately by using the “localization” function of the generated second-level content index information.

According to some embodiments, the second-level index data includes: the second descriptive text corresponding to each second video segment in the second video segment set obtained by performing video segmentation on the target video, the text vector determined based on the second descriptive text, and the start timestamp and end timestamp of each second video segment in the target video; the first-level index data includes: the first descriptive text corresponding to each first video segment in the first video segment set obtained by performing video segmentation on the target video, and the start timestamp and end timestamp of each first video segment in the target video. The first content index information includes first time information.

Furthermore, according to some embodiments, as shown in FIG. 4, performing, in response to obtaining the second identifier and the second content, retrieval in the second-level index data based on the first content index information to obtain the first target content for answering the query instruction (step 2104) includes: determining, based on the first time information, at least one second video segment, whose time period formed by its start timestamp and end timestamp contains the first time information, in the second video segment set (step 410); determining, based on the text vector, at least one second video segment in the second video segment set that matches the query instruction (step 420); and determining, based on the union of the at least one second video segment containing the second time information and the at least one second video segment matching with the query instruction, first target content for answering the query instruction (step 430).

Through the above embodiments, dual precise anchoring of video content in both the temporal and semantic dimensions is achieved, thereby greatly improving the recall rate and accuracy of recalling target content from massive video segments.

Specifically, in some examples, when the system determines by the first-level index data that the content is insufficient for answering and generates the first content index information containing the first-time information, its retrieval logic is not a single-dimensional retrieval but instead it adopts a strategy that combines “temporal filtering” and “semantic matching” in parallel. First, filtering, based on the first information (such as the potential time range determined based on the first-level index data), candidate segments that contain that range on the timeline in the second-level index data; simultaneously, searching segments with the highest semantic relevance in the second-level index data by using the vector features of the query instruction . Finally, determining the first target content by taking the union of the two types of candidate segments.

This union strategy fully accounts for the uncertainty in video understanding: it ensures the extraction of details within a known time range while using semantic matching to compensate for omissions that may result from temporal localization deviations based on the first-level index data, thereby ensuring that the output first target content can cover all key clues required for answering the query instruction.

According to some embodiments, generating the third identifier and third content, or generating the fourth identifier and fourth content, by the large language model based on the query instruction and the first target content retrieved for answering the query instruction includes: generating a third identifier and third content, or generating a fourth identifier and fourth content, by the large language model based on the second descriptive text, start timestamp, and end timestamp corresponding to each second video segment in the union, and the query instruction.

The descriptions of the third identifier and third content, and the fourth identifier and fourth content, are as described above and will not be repeated here.

In the above embodiments, the large language model can constructs a micro-temporal graph with logical coherence by deeply analyzing the second descriptive texts corresponding to the second video segments retrieved through the two parallel operations described above and combining the precise start and end timestamps of the second video segments in the raw video. This multidimensional input method, which combines “time coordinates” and “textual semantics,” enables the model to compare the causal relationships or action continuity between different segments, much like a human reviewer.

For example, when the query instruction involves complex action causal analysis, the large language model may examine whether there is a logical progression in the descriptive texts of adjacent timestamp segments to determine whether the first target content currently obtained constitutes a complete chain of evidence.

When the large language model determines that the second descriptive texts within the union have covered all details sufficient to support to obtained a conclusion, it may output the third identifier and third content containing the final answer.

In some embodiments, the answer generated by the large language model may include time information corresponding to that answer, such as the start and end timestamps of the video segment precisely cited by the model in the target video, thereby enabling an accurate response based on “traceable evidence”.

Conversely, if the large language model determines that the second descriptive texts within the union are insufficient for answering the query instruction, for example, when it is determined during the parsing process that key information points are discontinuous in the temporal sequence, or that the descriptive texts are ambiguous with respect to key details, the model will output the fourth identifier and more targeted second content index information. Accordingly, it is ensured that each conclusion output by the system has been subjected to rigorous temporal logic verification, thereby avoiding, to the greatest extent, misjudgment caused by information fragmentation and achieving highly accurate in understanding long-form video content.

According to some embodiments, as shown in FIG. 5, the first operation (step 210) may further include: performing, in response to obtaining the fourth identifier and the fourth content, retrieval in the target video based on the second content index information to obtain second target content for answering the query instruction (step 2106); and obtaining, based on the second target content and the query instruction, the answer corresponding to the query instruction by the large language model (step 2107).

Specifically, in response to the generation of the fourth identifier, the target video in the third-level index may be directly invoked. In this process, the second content index information serves to locate key information in the target video for answering the query instruction, and it can direct the system to precisely extract the second target content highly relevant to the query instruction from the massive raw video stream.

In some embodiments, the second target content may be one or more high-quality video segments, which contain uncompressed raw visual and audio details, thereby eliminating information distortion that may be introduced by text summarization or feature extraction in preceding levels and ensuring the reliability of the system when facing extremely challenging analysis tasks.

According to some embodiments, the second-level index data includes: the start timestamp and end timestamp, in the target video, of each second video segment in the second video segment set obtained by performing video segmentation on the target video. At this point, the second content index information may include second time information, wherein the second time information represents the time period corresponding to the target video for answering the query instruction.

In some embodiments, generating the third identifier and third content, or generating the fourth identifier and fourth content, by the large language model based on the query instruction and the first target content includes: generating the third identifier and third content, or generating the fourth identifier and fourth content, by the large language model based on the query instruction, the first target content, and the start timestamp and end timestamp respectively corresponding to the at least one second video segment corresponding to the retrieved first target content. At this point, the second content index information in the generated fourth content may include second time information, which is used to characterize precise time-period information or time-point information in the target video for answering the query instruction.

In some examples, similarly, the second time information may be complete start/end timestamps of a second video segment matched in the second-level index, or it may be a more vague time range predicted by the large language model, which is not limited herein. Using this second time information and the target video, video frames or video segments in the target video that contain this second time information may be obtained to serve as the second target content.

After obtaining the second target content, the large language model may directly perform multimodal deep analysis based on these raw video segments and the query instruction of the user to obtain the final answer. At this stage, the large language model may fully leverage its multimodal understanding capabilities to perform comprehensively analysis on subtle movements, object features, textual information, and environmental context in the video segments. This ultimate verification logic, which is based on raw video data, marks not only the closure of the retrieval loop but also fundamentally ensures that the generated answer possesses extremely high confidence and objectivity, thereby perfectly balancing the dual requirements of “search efficiency” and “depth of understanding” in long-form video processing.

In some embodiments, the obtained second target content may be either a raw video segment retrieved based on the second content index information or a feature sequence obtained by preprocessing the raw video segment, which is not limited herein.

According to some embodiments, obtaining the answer corresponding to the query instruction by the large language model based on the second target content and the query instruction includes: generating a fifth identifier and fifth content, or generating a sixth identifier, by the large language model based on the second target content and the query instruction.

In the above embodiments, the fifth content includes the answer corresponding to the query instruction, wherein the answer is generated based on the second target content, and the fifth identifier is used to identify that the second target content is sufficient for answering the query instruction; the sixth identifier is used to identify that the second target content is insufficient for answering the query instruction, and the sixth identifier is used to guide the execution of a preset second operation, wherein the second operation is used to obtain the answer corresponding to the query instruction based on the target video.

Specifically, when the large language model generates the fifth identifier, it means that the second target content provides conclusive visual evidence, which is sufficient to directly answer the query instruction. The fifth content generated at this point is the final answer. The introduction of the sixth indicator addresses the “hallucination” problem of a multimodal model when facing extreme cases. If the model determines that, even after reviewing the raw video, effective clues still cannot be obtained due to reasons such as excessively dim ambient light, the target object being outside the frame, or video damage, it will output the sixth identifier to explicitly inform the user that the current video content is insufficient for answering the instruction.

In some embodiments, the preset second operation may be any operation, which is different from the first operation, capable of answering the query instruction based on the target video, for example, at least one method of directly using a VLM as described above before describing the embodiments of the present disclosure.

Such design prevents the model from forcibly generating an incorrect answer in the case of insufficient evidence, thereby maintaining the rigor of interaction and the credibility of the system. Accordingly, efficient response to routine queries is ensured, while determination accuracy in extremely complex scenarios is also ensured.

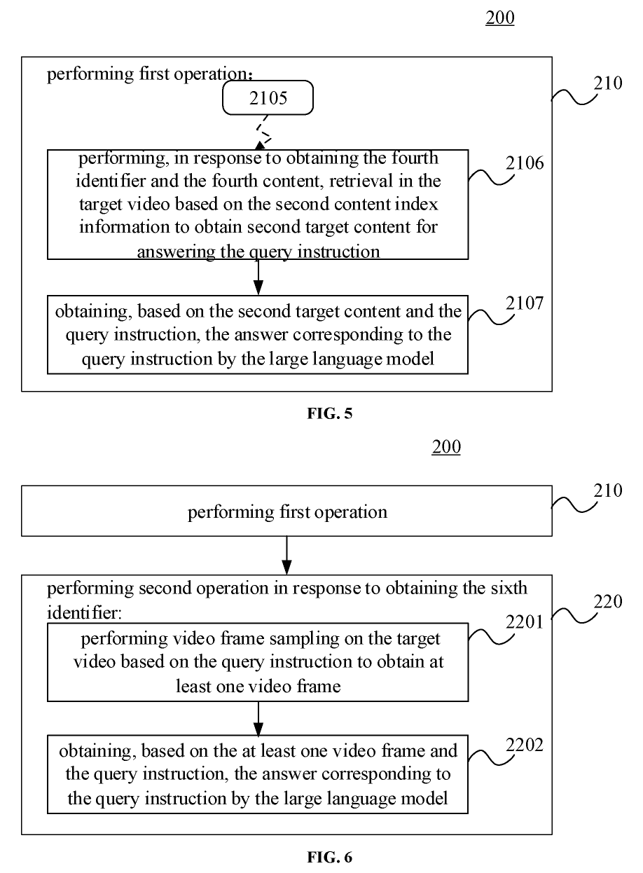

According to some embodiments, as shown in FIG. 6, the method 200 of the present disclosure may further include: performing, in response to obtaining the sixth identifier, the second operation (step 220), wherein the second operation includes: performing, in response to obtaining the sixth identifier, video frame sampling on the target video based on the query instruction to obtain at least one video frame (step 2201); and obtaining, based on the at least one video frame and the query instruction, the answer corresponding to the query instruction by the large language model (step 2202).

In the case of obtaining the sixth indicator, that is, determining that the existing second target content (typically the video segment) is still insufficient to support a conclusion, performing targeted frame sampling on the target video enables the obtaining of at least one video frame containing key instantaneous details, thereby providing final data support for resolving complex queries involving information hidden within extremely short moments or minute spatial regions.

In some embodiments, the sampling strategy may be dynamically adjusted based on the semantic features of the query instruction, which is not limited herein. After obtaining these at least one video frame, the large language model is no longer constrained by the temporal redundancy of the video stream but instead focuses its attention on the spatial details in the static frame.

In an example embodiment of the present disclosure, unstructured raw long-form video data may be pre-converted into structured, multi-granularity, retrievable, and reusable multi-level indexed data, while fully preserving the global context, temporal logic, and fine-grained details of the video, thereby providing a foundation for efficient navigation in the online stage. Specifically, the multi-level index data may include four levels of index data, such as:
third-level index data: namely the target video, which provides the most direct visual details;
second-level index data: the visual description text and audio text corresponding to each second video segment in the second video segment set obtained by performing video segmentation on the target video, the text vector determined based on at least one of the visual description text and audio text, and the start timestamp and end timestamp of each second video segment in the target video.
first-level index data: the first descriptive texts (e.g., the summary text generation which is based on the second descriptive text corresponding to the corresponding second video segment and the target video) respectively corresponding to the plurality of first video segments, which is obtained by performing video segment concatenation on the clustered second video segments that are semantically similar and temporally adjacent, and the start timestamp and end timestamp of each first video segment in the target video.
zeroth-level index data: the summary text of the target video (e.g., the corresponding second description text generation which is based on all second video segments).

After obtaining the query instruction, namely in an online stage, the system may, based on the multi-level index data constructed offline, use the large language model to simulate human cognitive process and execute a top-down, coarse-to-fine adaptive navigation strategy, progressively proceed to a finer level of granularity only when necessary, while also supporting an early termination mechanism (i.e., it is determined that an answer can be generated), thereby minimizing computational overhead and inference latency while ensuring accuracy of the answer.

Specifically, in some examples, after obtaining the query instruction, the system may first use the summary text as context, analyze the query intent of the user based on the large language model, and generate the strategy guidance text to guide subsequent operations that perform information retrieval in the first-level index data to answer the query instruction. Therefore, furthermore, the large language model analyzes the first-level index data by combining the query instruction and the strategy guidance text. At this point, the large language model may evaluate: if the current first-level index data is sufficient to answer the question, an answer is directly output and an “early exit” is triggered to save subsequent computational overhead; If the current first-level index data is insufficient to answer the question, a target time interval is predicted to guide the system to proceed to the finer-grained second-level index data for content localization.

If the aforementioned process determines that further exploration is needed to answer the query instruction, the system may employ a parallel process for performing content retrieval on the second-level index data: 1) employing a “spatial range scaling” strategy to obtain corresponding second-level video segment candidates directly based on the target time interval predicted above, and this strategy excels at handling tasks involving temporal sequences and causal dependencies; 2) employing a “semantic matching” strategy to retrieve candidate second video segments highly relevant to the query instruction based on the text vector. The system combines the candidate results filtered by the above parallel processes to serve as input for subsequent fine-grained navigation. The large language model performs analysis based on the visual descriptive texts and audio texts respectively corresponding to the combined second video segment candidates and evaluates whether an answer can be generated: if it is determined that the textual evidences are sufficient, a direct response is provided; if it is determined that confirmation of highly detailed visual information is still involved, precise target timestamps (such as the start and end points in the target video) may be further output.

If the above process determines that further exploration is needed for answering the query instruction, a video frame sequence in the third-level index data (i.e., the target video) corresponding to the target timestamp may be extracted, this short segment of highly relevant video frames is then fed into a Visual-Language Model (VLM) for final verification and the answer is output, thereby reducing the processing load of the VLM and avoiding noise interference caused by redundant frames.

Furthermore, to ensure the overall robustness of the system and prevent the appearance of response failure caused by information missing or misunderstanding during the navigation process, a fallback mechanism may be designed, that is, when none of the preceding stages of the navigation process can generate an answer with sufficient confidence, the system automatically falls back to the standard VLM inference mode and completes the end-to-end inference after sampling the video to ensure basic accuracy.

According to the embodiments of the present disclosure, the method can be applied to various video intelligent understanding systems or video intelligent question-answering systems. For example, application scenarios for knowledge question answering and summary generation based on videos, content management platforms for event retrieval and plot understanding based on massive long-form videos, and the like. By constructing multi-level index data offline, the method can greatly reduce the computational cost of each online question-answering process, improve temporal relevance and detail effectiveness in event retrieval, increase response speed, significantly reduce online GPU usage and token consumption, and improve throughput of the system.

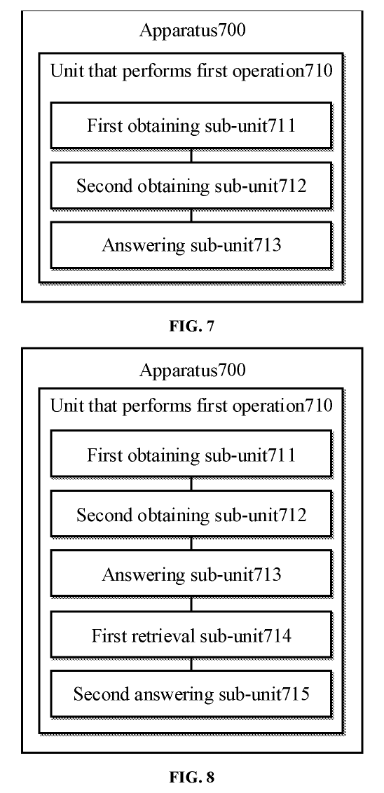

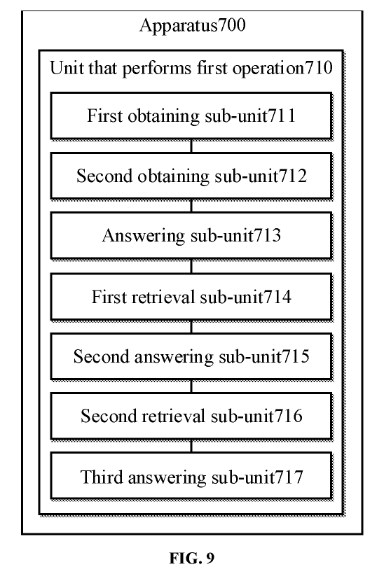

According to embodiments of the present disclosure, as shown in FIG. 7, an apparatus 700 for answering based on a long-form video is further provided, including: a unit 710 configured to perform a first operation. The unit 710 that is configured to perform the first operation includes: a first obtaining unit 711, configured to obtain a query instruction to be answered; a second obtaining unit 712, configured to obtain multi-level index data for answering the query instruction, wherein the multi-level index data includes: first-level index data and second-level index data, wherein the multi-level index data corresponds to video information of different granularities of the target video, and the higher the level of the index data, the finer the granularity of the video information; and an answering unit 713, configured to generate a first identifier and first content, or generate a second identifier and second content, by a large language model based on the query instruction and the first-level index data.

According to the embodiments of the present disclosure, the first content includes an answer corresponding to the query instruction, wherein the answer is generated based on the first-level index data, and the first identifier is used to identify that the content in the first-level index data is sufficient for answering the query instruction; the second content includes corresponding first content index information for answering the query instruction, wherein the second identifier is used to identify that the content in the first-level index data is insufficient for answering the query instruction, wherein the first content index information is used for performing content retrieval in the second-level index data to answer the query instruction, and wherein the first content index information is used for obtaining the answer to the query instruction.

Here, the characteristics relevant to the first-level index data and second-level index data in apparatus 700 for answering based on long-form videos are similar to those of the relevant data in method 200 described above and will not be repeated herein.

According to some embodiments, the multi-level index data further includes: zeroth-level index data, wherein the zeroth-level index data includes the summary text corresponding to the target video. The response sub-unit 713 further includes units configured to perform the following operations: generating, based on the query instruction and the summary text, a strategy guidance text by the large language model, wherein the strategy guidance text is used for guiding the large language model to perform information retrieval in the first-level index data for answering the query instruction; and generating the first identifier and the first content, or generating the second identifier and the second content, by the large language model based on the strategy guidance text, the query instruction, the summary text, and the first-level index data.

According to some embodiments, the multi-level index data further includes: third-level index data, wherein the third-level index data includes the target video. As shown in FIG. 8, the unit 710 for performing the first operation may further include: a first retrieval sub-unit 714 configured to perform, in response to obtaining the second identifier and the second content, retrieval in the second-level index data based on the first content index information to obtain first target content for answering the query instruction; a second answering sub-unit 715 configured to generate a third identifier and third content, or generating a fourth identifier and fourth content, by the large language model based on the query instruction and the first target content. The third content includes the answer corresponding to the query instruction, wherein the answer is generated based on the second-level index data, and the third identifier is used to identify that the content in the second-level index data is sufficient for answering the query instruction; wherein the fourth content includes corresponding second content index information for answering the query instruction, wherein the fourth identifier is used to identify that the content in the second-level index data is insufficient for answering the query instruction, wherein the second content index information is used for performing content retrieval in the target video for answering the query instruction, and wherein the second content index information is used for obtaining the answer to the query instruction.

According to some embodiments, the second-level index data includes: the second descriptive text corresponding to each second video segment in the second video segment set obtained by performing video segmentation on the target video, the text vector determined based on the second descriptive text, and the start timestamp and end timestamp of each second video segment in the target video; the first-level index data includes: the first descriptive text corresponding to each first video segment in the first video segment set obtained by performing video segmentation on the target video, and the start timestamp and end timestamp of each first video segment in the target video, wherein the first content index information includes first time information.

According to some embodiments, the first retrieval sub-unit 714 further includes units for performing the following operations: determining, based on the first time information, at least one second video segment, whose time period formed by its start timestamp and end timestamp contains the first time information, in the second video segment set; determining, based on the text vector, at least one second video segment in the second video segment set that matches the query instruction; and determining, based on the union of the at least one second video segment containing the second time information and the at least one second video segment matching with the query instruction, the first target content for answering the query instruction.

According to some embodiments, the second response sub-unit 715 includes units for performing the following operations: generating a third identifier and third content, or generating a fourth identifier and fourth content, by the large language model based on the second descriptive text, the start timestamp and end timestamp corresponding to each second video segment in the union, and the query instruction,.

According to an embodiment of the present disclosure, as shown in FIG. 9, the unit 710 for performing the first operation further includes: a second retrieval sub-unit 716 configured to, perform, in response to obtaining the fourth identifier and the fourth content, retrieval in the target video based on the second content index information to obtain second target content for answering the query instruction; and a third response sub-unit 717 configured to obtain, based on the second target content and the query instruction, the answer corresponding to the query instruction by the large language model .

According to some embodiments, the second-level index data includes: the start timestamp and end timestamp, in the target video, of each second video segment in the second video segment set obtained by performing video segmentation on the target video, the second content index information includes second time information, wherein the second time information identifies the time period corresponding to the target video for answering the query instruction.

According to some embodiments, the third answering sub-unit 717 includes unit for performing the following operations: generating a fifth identifier and fifth content, or generating a sixth identifier, by the large language model based on the second target content and the query instruction. The fifth content includes the answer corresponding to the query instruction, wherein the answer is generated based on the second target content, and the fifth identifier is used to indicate that the second target content is sufficient for answering the query instruction; the sixth identifier is used to identify that the second target content is insufficient for answering the query instruction, and the sixth identifier is used to guide the execution of a preset second operation, wherein the second operation is used to obtain the answer corresponding to the query instruction based on the target video.

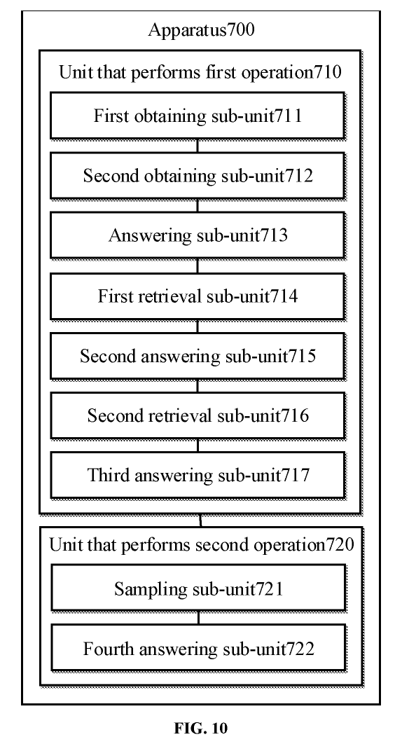

In some embodiments, as shown in FIG. 10, the apparatus 700 for answering based on the long-form video further includes: a unit 720 configured to perform the second operation in response to obtaining the sixth identifier, wherein the unit 720 that is configured to perform the second operation includes: a sampling sub-unit 721 configured to perform video frame sampling on the target video based on the query instruction to obtain at least one video frame; and a fourth answering sub-unit 722 configured to obtain the answer corresponding to the query instruction by a large language model based on the at least one video frame and the query instruction.

Here, the operations of the aforementioned units 710-720 (including the sub-units thereof) of the apparatus 700 for answering based on long-form videos are similar to the operations of steps 210-220 (including the sub-units thereof) described above and will not be repeated here.

In the technical solution of the present disclosure, any processing of information involved, such as collection, storage, use, processing, transmission, provision, and disclosure of user personal information, complies with relevant laws and regulations and does not violate public order and good morals.

According to embodiments of the present disclosure, there is also provided an electronic device, a readable storage medium, and a computer program product.

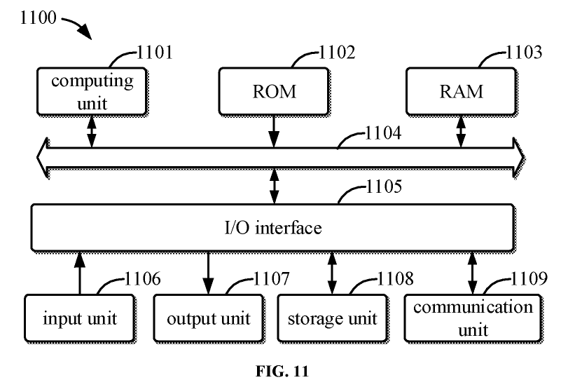

Referring to FIG. 11, a structural block diagram of an electronic device 1100 that may be a server or client of the present disclosure is now described, which is an example of a hardware device that may be applied to aspects of the present disclosure. Electronic devices are intended to represent various forms of digital electronic computer devices, such as laptop computers, desktop computers, workstations, personal digital assistants, servers, blade servers, mainframe computers, and other suitable computers. The electronic devices may also represent various forms of mobile devices, such as personal digital processing, cellular telephones, smart phones, wearable devices, and other similar computing devices. The components shown herein, their connections and relationships, and their functions are merely as examples, and are not intended to limit the implementations of the disclosure described and/or claimed herein.

As shown in FIG. 11, the electronic device 1100 includes a computing unit 1101, which may perform various appropriate actions and processing according to a computer program stored in a read-only memory (ROM) 1102 or a computer program loaded into a random access memory (RAM) 1103 from a storage unit 1108. In the RAM 1103, various programs and data required by the operation of the electronic device 1100 may also be stored. The computing unit 1101, the ROM 1102, and the RAM 1103 are connected to each other through a bus 1104. Input/output (I/O) interface 1105 is also connected to the bus 1104.

A plurality of components in the electronic device 1100 are connected to a I/O interface 1105, including: an input unit 1106, an output unit 1107, a storage unit 1108, and a communication unit 1109. The input unit 1106 may be any type of device capable of inputting information to the electronic device 1100, the input unit 1106 may receive input digital or character information and generate a key signal input related to user setting and/or function control of the electronic device, and may include, but is not limited to, a mouse, a keyboard, a touch screen, a track pad, a trackball, a joystick, a microphone, and/or a remote control. The output unit 1107 may be any type of device capable of presenting information, and may include, but are not limited to, a display, a speaker, a video/audio output terminal, a vibrator, and/or a printer. The storage unit 1108 may include, but is not limited to, a magnetic disk and an optical disk. The communication unit 1109 allows the electronic device 1100 to exchange information/data with other devices over a computer network, such as the Internet, and/or various telecommunication networks, and may include, but is not limited to, a modem, a network card, an infrared communication device, a wireless communication transceiver and/or a chipset, such as a Bluetooth device, a 802.11 device, a WiFi device, a WiMAX device, a cellular communication device, and/or the like.

The computing unit 1101 may be a variety of general and/or special purpose processing components with processing and computing capabilities. Some examples of the computing unit 1101 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, etc. The computing unit 1101 performs the various methods and processes described above, such as method 200. For example, in some embodiments, the method 200 may be implemented as a computer software program tangibly contained in a machine-readable medium, such as the storage unit 1108. In some embodiments, part or all of the computer program may be loaded and/or installed onto the electronic device 1100 via the ROM 1102 and/or the communication unit 1109. When the computer program is loaded to the RAM 1103 and executed by the computing unit 1101, one or more steps of the method 200 described above may be performed. Alternatively, in other embodiments, the computing unit 1101 may be configured to perform the method 200 by any other suitable means (e.g., with the aid of firmware).

Various embodiments of the systems and techniques described above herein may be implemented in a digital electronic circuit system, an integrated circuit system, a field programmable gate array (FPGA), an application specific integrated circuit (ASIC), a dedicated standard product (ASSP), a system of system on a chip system (SoC), a complex programmable logic device (CPLD), computer hardware, firmware, software, and/or combinations thereof. These various embodiments may include: implementation in one or more computer programs that may be executed and/or interpreted on a programmable system including at least one programmable processor, where the programmable processor may be a dedicated or universal programmable processor that may receive data and instructions from a storage system, at least one input device, and at least one output device, and transmit data and instructions to the storage system, the at least one input device, and the at least one output device.

The program code for implementing the method of the present disclosure may be written in any combination of one or more programming languages. These program code may be provided to a processor or controller of a general-purpose computer, a special purpose computer, or other programmable data processing device such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium, which may contain or store a program for use by or in connection with an instruction execution system, device, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of a machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

To provide interaction with a user, the systems and techniques described herein may be implemented on a computer having: a display device (e.g., a CRT (cathode ray tube) or an LCD (liquid crystal display) monitor) for displaying information to a user; and a keyboard and pointing device (e.g., a mouse or trackball) by which a user may provide input to the computer. Other types of devices may also be used to provide interaction with a user; for example, the feedback provided to the user may be any form of perception feedback (e.g., visual feedback, auditory feedback, or tactile feedback); and the input from the user may be received in any form, including acoustic input, voice input, or haptic input.

The systems and techniques described herein may be implemented in a computing system including a back-end component(e.g., as a data server), or a computing system including a middleware component (e.g., an application server), or a computing system including a front-end component (e.g., a user computer with a graphic user interface or a web browser, the user may interact with implementations of the systems and techniques described herein through the graphic user interface or the web browser), or in a computing system including any combination of such back-end components, middleware components, or front-end components. The components of the system may be interconnected by digital data communication (e.g., a communications network) in any form or medium. Examples of communication networks include a local area network (LAN), a wide area network (WAN), the Internet, and a blockchain network.

The computer system may include a client and a server. Clients and servers are generally remote from each other and typically interact through a communication network. The relationship between clients and servers is generated by computer programs running on respective computers and having a client-server relationship to each other. The server may be a cloud server, or may be a server of a distributed system, or a server incorporating a blockchain.

It should be understood that the various forms of processes shown above may be used, and the steps may be reordered, added, or deleted. For example, the steps described in the present disclosure may be performed in parallel or sequentially or in a different order, as long as the results expected by the technical solutions disclosed in the present disclosure can be achieved, and no limitation is made herein.

Although embodiments or examples of the present disclosure have been described with reference to the accompanying drawings, it should be understood that the foregoing methods, systems, and devices are merely embodiments or examples, and the scope of the present disclosure is not limited by these embodiments or examples, but is only defined by the authorized claims and their equivalents. Various elements in the embodiments or examples may be omitted or may be replaced by equivalent elements thereof. Further, the steps may be performed by a different order than described in this disclosure. Further, various elements in the embodiments or examples may be combined in various ways. Importantly, with the evolution of the technology, many elements described herein may be replaced by equivalent elements appearing after the present disclosure.

What is claimed is:

1. A method for answering based on a long-form video, comprising: performing a first operation, wherein the first operation comprises:
obtaining a query instruction to be answered;
obtaining multi-level index data for answering the query instruction, wherein the multi-level index data comprises: first-level index data and second-level index data, wherein the multi-level index data corresponds to video information of different granularities of the target video, and the higher the level of the index data, the finer the granularity of the video information; and
generating a first identifier and first content, or generating a second identifier and second content, by a large language model based on the query instruction and the first-level index data,
wherein the first content comprises an answer corresponding to the query instruction, wherein the answer is generated based on the first-level index data, and the first identifier is used to identify that the content in the first-level index data is sufficient for answering the query instruction;
wherein the second content comprises corresponding first content index information for answering the query instruction, wherein the second identifier is used to identify that the content in the first-level index data is insufficient for answering the query instruction, wherein the first content index information is used for performing content retrieval in the second-level index data to answer the query instruction, and wherein the first content index information is used for obtaining the answer to the query instruction.

2. The method of claim 1, wherein
the first-level index data comprises: a first descriptive text corresponding to each first video segment in a first video segment set obtained by performing video segmentation on the target video,
the second-level index data comprises: a second descriptive text corresponding to each second video segment in a second video segment set obtained by performing video segmentation on the target video.

3. The method of claim 2, wherein the second descriptive text comprises: a visual descriptive text corresponding to the corresponding second video segment and an audio text corresponding to the second video segment, wherein the visual descriptive text is obtained by a visual language model based on at least one video frame in the second video segment and the audio text corresponding to the second video segment.

4. The method of claim 2, wherein
the second-level index data further comprises: a start timestamp and an end timestamp of each second video segment in the target video;
the first-level index data further comprises: a start timestamp and an end timestamp of each first video segment in the target video,
wherein the first content index information comprises first time information, wherein the first time information represents time interval information in the target video for answering the query instruction.

5. The method of claim 4, wherein the second-level index data further comprises: a text vector determined based on the second descriptive text, wherein the first-level index data is determined by the following operations:
clustering, based on the text vector, second video segments that are semantically similar and temporally adjacent to form a plurality of video segment clusters;
concatenating, for each video segment cluster in the plurality of video segment clusters, the second video segments in the video segment cluster in chronological order to obtain the first video segment corresponding to the video segment cluster;
obtaining summary text corresponding to the target video; and
obtaining, for each video segment cluster within the plurality of video segment clusters, the first description text corresponding to the first video segment corresponding to the video segment cluster by the large language model based on the summary text, the second description text corresponding to each second video segment in the video segment cluster, and the start timestamp and end timestamp corresponding to the each second video segment,
wherein the first video segments respectively corresponding to the plurality of video segment clusters form the first video segment set.

6. The method of claim 1, wherein the multi-level index data further comprises: zeroth-level index data, wherein the zeroth-level index data comprises summary text corresponding to the target video,
wherein generating the first identifier and first content, or generating the second identifier and second content, by the large language model based on the query instruction and the first-level index data comprises:
generating, based on the query instruction and the summary text, a strategy guidance text by the large language model, wherein the strategy guidance text is used for guiding the large language model to perform information retrieval in the first-level index data to answer the query instruction; and
generating the first identifier and the first content, or generating the second identifier and the second content, by the large language model based on the strategy guidance text, the query instruction, the summary text, and the first-level index data.

7. The method of claim 1, wherein the multi-level index data further comprises: third-level index data, wherein the third-level index data comprises the target video, wherein the first operation further comprises:
performing, in response to obtaining the second identifier and the second content, retrieval in the second-level index data based on the first content index information to obtain first target content for answering the query instruction;
generating a third identifier and third content, or generating a fourth identifier and fourth content, by the large language model based on the query instruction and the first target content, wherein
the third content comprises the answer corresponding to the query instruction, wherein the answer is generated based on the second-level index data, and the third identifier is used to identify that the content in the second-level index data is sufficient for answering the query instruction;
wherein the fourth content comprises corresponding second content index information for answering the query instruction, wherein the fourth identifier is used to identify that the content in the second-level index data is insufficient for answering the query instruction, wherein the second content index information is used for performing content retrieval in the target video to answer the query instruction, and wherein the second content index information is used for obtaining the answer to the query instruction.

8. The method of claim 7, wherein
the second-level index data comprises: the second descriptive text corresponding to each second video segment in the second video segment set obtained by performing video segmentation on the target video, the text vector determined based on the second descriptive text, and the start timestamp and end timestamp of each second video segment in the target video;
the first-level index data comprises: the first descriptive text corresponding to each first video segment in the first video segment set obtained by performing video segmentation on the target video, and the start timestamp and end timestamp of each first video segment in the target video, wherein the first content index information comprises first time information, wherein
performing, in response to obtaining the second identifier and the second content, retrieval in the second-level index data based on the first content index information to obtain the first target content for answering the query instruction comprises:
determining, based on the first time information, at least one second video segment, whose time period formed by its start timestamp and end timestamp contains the first time information, in the second video segment set;
determining, based on the text vector, at least one second video segment in the second video segment set that matches the query instruction; and
determining, based on the union of the at least one second video segment containing the second time information and the at least one second video segment matching with the query instruction, the first target content for answering the query instruction.

9. The method of claim 8, wherein generating the third identifier and third content, or generating the fourth identifier and fourth content, by the large language model based on the query instruction and the first target content retrieved for answering the query instruction comprises:
generating the third identifier and third content, or generating the fourth identifier and fourth content, by the large language model based on the second descriptive text, start timestamp, and end timestamp corresponding to each second video segment in the union, and the query instruction.

10. The method of claim 7, wherein the first operation further comprises:
performing, in response to obtaining the fourth identifier and the fourth content, retrieval in the target video based on the second content index information to obtain second target content for answering the query instruction; and
obtaining, based on the second target content and the query instruction, the answer corresponding to the query instruction by the large language model.

11. The method of claim 10, wherein the second-level index data comprises: the start timestamp and end timestamp, in the target video, of each second video segment in the second video segment set obtained by performing video segmentation on the target video, wherein the second content index information comprises second time information, wherein
the second time information identifies the time period corresponding to the target video for answering the query instruction.

12. The method of claim 10, wherein obtaining the answer corresponding to the query instruction by the large language model based on the second target content and the query instruction comprises:
generating a fifth identifier and fifth content, or generating a sixth identifier, by the large language model based on the second target content and the query instruction, wherein
the fifth content comprises the answer corresponding to the query instruction, wherein the answer is generated based on the second target content, and the fifth identifier is used to identify that the second target content is sufficient for answering the query instruction;
wherein the sixth identifier is used to identify that the second target content is insufficient for answering the query instruction, and the sixth identifier is used to guide the execution of a preset second operation, wherein the second operation is used to obtain the answer corresponding to the query instruction based on the target video.

13. The method of claim 12, wherein the method further comprises: performing, in response to obtaining the sixth identifier, the second operation, wherein the second operation comprises:
performing, based on the query instruction, video frame sampling on the target video to obtain at least one video frame; and
obtaining, based on the at least one video frame and the query instruction, the answer corresponding to the query instruction by the large language model.

14. An electronic device, comprising:
a memory storing one or more programs configured to be executed by one or more processors, the one or more programs including instructions for performing operations comprising: performing a first operation, wherein the first operation comprises:
obtaining a query instruction to be answered;
obtaining multi-level index data for answering the query instruction, wherein the multi-level index data comprises: first-level index data and second-level index data, wherein the multi-level index data corresponds to video information of different granularities of the target video, and the higher the level of the index data, the finer the granularity of the video information; and
generating a first identifier and first content, or generating a second identifier and second content, by a large language model based on the query instruction and the first-level index data,
wherein the first content comprises an answer corresponding to the query instruction, wherein the answer is generated based on the first-level index data, and the first identifier is used to identify that the content in the first-level index data is sufficient for answering the query instruction;
wherein the second content comprises corresponding first content index information for answering the query instruction, wherein the second identifier is used to identify that the content in the first-level index data is insufficient for answering the query instruction, wherein the first content index information is used for performing content retrieval in the second-level index data to answer the query instruction, and wherein the first content index information is used for obtaining the answer to the query instruction.

15. The electronic device according to claim 14, wherein the multi-level index data further comprises: zeroth-level index data, wherein the zeroth-level index data comprises summary text corresponding to the target video,
wherein generating the first identifier and first content, or generating the second identifier and second content, by the large language model based on the query instruction and the first-level index data comprises:
generating, based on the query instruction and the summary text, a strategy guidance text by the large language model, wherein the strategy guidance text is used for guiding the large language model to perform information retrieval in the first-level index data to answer the query instruction; and
generating the first identifier and the first content, or generating the second identifier and the second content, by the large language model based on the strategy guidance text, the query instruction, the summary text, and the first-level index data.

16. The electronic device according to claim 14, wherein the multi-level index data further comprises: third-level index data, wherein the third-level index data comprises the target video, wherein the first operation further comprises:
performing, in response to obtaining the second identifier and the second content, retrieval in the second-level index data based on the first content index information to obtain first target content for answering the query instruction;
generating a third identifier and third content, or generating a fourth identifier and fourth content, by the large language model based on the query instruction and the first target content, wherein
the third content comprises the answer corresponding to the query instruction, wherein the answer is generated based on the second-level index data, and the third identifier is used to identify that the content in the second-level index data is sufficient for answering the query instruction;
wherein the fourth content comprises corresponding second content index information for answering the query instruction, wherein the fourth identifier is used to identify that the content in the second-level index data is insufficient for answering the query instruction, wherein the second content index information is used for performing content retrieval in the target video to answer the query instruction, and wherein the second content index information is used for obtaining the answer to the query instruction.

17. The electronic device according to claim 16, wherein the first operation further comprises:
performing, in response to obtaining the fourth identifier and the fourth content, retrieval in the target video based on the second content index information to obtain second target content for answering the query instruction; and
obtaining, based on the second target content and the query instruction, the answer corresponding to the query instruction by the large language model.

18. The electronic device of claim 17, wherein obtaining the answer corresponding to the query instruction by the large language model based on the second target content and the query instruction comprises:
generating a fifth identifier and fifth content, or generating a sixth identifier, by the large language model based on the second target content and the query instruction, wherein
the fifth content comprises the answer corresponding to the query instruction, wherein the answer is generated based on the second target content, and the fifth identifier is used to identify that the second target content is sufficient for answering the query instruction;
wherein the sixth identifier is used to identify that the second target content is insufficient for answering the query instruction, and the sixth identifier is used to guide the execution of a preset second operation, wherein the second operation is used to obtain the answer corresponding to the query instruction based on the target video.

19. The electronic device of claim 18, wherein the method further comprises: performing, in response to obtaining the sixth identifier, the second operation, wherein the second operation comprises:
performing, based on the query instruction, video frame sampling on the target video to obtain at least one video frame; and
obtaining, based on the at least one video frame and the query instruction, the answer corresponding to the query instruction by the large language model.

20. A non-transitory computer-readable storage medium storing computer instructions, wherein the computer instructions are used to cause the computer to perform the following operations: performing a first operation, wherein the first operation comprises:
obtaining a query instruction to be answered;
obtaining multi-level index data for answering the query instruction, wherein the multi-level index data comprises: first-level index data and second-level index data, wherein the multi-level index data corresponds to video information of different granularities of the target video, and the higher the level of the index data, the finer the granularity of the video information; and
generating a first identifier and first content, or generating a second identifier and second content, by a large language model based on the query instruction and the first-level index data,
wherein the first content comprises an answer corresponding to the query instruction, wherein the answer is generated based on the first-level index data, and the first identifier is used to identify that the content in the first-level index data is sufficient for answering the query instruction;
wherein the second content comprises corresponding first content index information for answering the query instruction, wherein the second identifier is used to identify that the content in the first-level index data is insufficient for answering the query instruction, wherein the first content index information is used for performing content retrieval in the second-level index data to answer the query instruction, and wherein the first content index information is used for obtaining the answer to the query instruction.
